(19) United States
(12) Patent Application Publication
(10) Pub. No.: US 2005/0068171 A1
(43) Pub. Date: Mar. 31, 2005

(54) Wearable security system and method

(75) Inventors: Timothy Patrick Kelliher, Scotia, NY (US); Peter Henry Tu, Schenectady, NY (US); Jens Rittscher, Schenectady, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 10/674,485

(22) Filed: Sep. 30, 2003

(51) Int. Cl. G08B 1/08

(52) U.S. Cl. 340/539.22

(57) ABSTRACT

A wearable security system integrates sensors, such as optical and acoustic sensors, a decision engine processor, a communications device, such as a cellular telephone, a location determination device, such as a GPS system, a device controller, and user feedback. A method of wearable security operates the wearable security system so that a user is aware of and able to control and interact with his or her environment, such as providing notice of potential threats or taking protective actions.

### BACKGROUND

The present disclosure generally relates to wearable computers. In particular, the present disclosure relates to wearable security systems and methods.

With the rising insecurity in the world, the well-to-do have resorted to bodyguards to provide for their physical security. One function of the bodyguard is to look and listen in directions where the guarded person is not. Bodyguards also provide assistance and advice when the person is being threatened and they communicate with emergency response systems. Bodyguards are trained to recognize threats in the environment before they harm the person being guarded and to take evasive actions proactively. Most people do not have access to a bodyguard.

Sometimes when crimes occur, there is less evidence than needed to convict a perpetrator. For the crime of date rape, there is a need for a way to detect a foreign substance being put into a drink, to detect personal boundaries being crossed, to contact emergency responders, and to provide evidence. Another example is stalking where a victim of a stalker is unable to prove violation of a restraining order. There is a need to recognize potential threats to a person in an environment and take action on their behalf to protect them.

Many large cities like London are wired with cameras. The issue is what to do with the information from all the cameras. To some extent there are not enough people to monitor all of the images being generated. There is a need for a system that protects a person by interacting with such systems.

### SUMMARY

The present disclosure is directed to systems and methods of wearable security that satisfy these and other needs.

One aspect is a system for wearable security, including a decisioning engine, a plurality of sensors, and a user feedback component. The decisioning engine selectively assesses events for potential threats to a user. The decisioning engine has at least one state transition model for determining the events, at least one segmentation routine for determining objects, and an inference engine for associating events with behaviors. The sensors are in communication with the decisioning engine. The sensors gather data about the environment. The objects are the result of segmenting the data by the segmentation routine. The user feedback component interacts with the user. The user feedback component is in communication with the decisioning engine. The decisioning engine, sensors and user feedback component reside in an article capable of being worn or carried by the user. In some embodiments, the system also includes a communications component for communicating with an external resource. The communications component is in communication with the decisioning engine and resides in the article. In some embodiments, the external resource includes at least one of the following: an off-board reasoning component, an external data component, an emergency response component, and an external sensor network. In some embodiments, the external sensor network includes at least one of the following: a camera, an audio component, a satellite component, and a chemical component. In some embodiments, the system also includes a spatial location component in communication with the decisioning engine. The spatial location component resides in the article. In some embodiments, the system also includes a device control component. The device control component controls at least some of the objects. The device control component is in communication with the decisioning engine. The device control component resides in the article.

Another aspect is a system for portable security that includes a plurality of sensors for gathering data, a user feedback component, a device controller, and a decisioning engine. The decisioning engine monitors an environment with the sensors, recognizes events, provides selective warnings with the user feedback component, and takes actions with the device controller. The decisioning engine has at least one state transition model for determining events, at least one segmentation routine for determining objects from the data, and an inference engine for associating events with behaviors. The device controller, the user feedback component, the communications component, the sensors, and the decisioning engine are capable of being worn or carried by a user. In some embodiments, the system also includes a communications component capable of being carried by the user. In some embodiments, the communications component communicates with an external sensor network. In some embodiments, the external sensor network includes a plurality of sensors. In some embodiments, the plurality of sensors includes at least one of the following: a camera, a microphone, a satellite sensor, and a chemical sensor. In some embodiments, the communications component communicates with at least one of the following: a reasoning engine, external data, and an emergency response system.

Another aspect is a method for wearable security. A wearable security system receives data from at least one sensor of the wearable security system. The wearable security system monitors the data for events. The wearable security system selectively associates behaviors with events. The wearable security system selectively assesses each event in the context of events and behaviors for a potential threat. The wearable security system provides selective notice of the potential threat. In some embodiments, monitoring data for events comprises the wearable security system segmenting data into objects and monitoring the objects for events. In some embodiments, the wearable security system provides selective notice of events. In some embodiments, a person is one of the objects. The wearable security system identifies the person and provides selective notice of the person. In some embodiments, the wearable security system controls the object. In some embodiments, the wearable security system maintains a selective history. In some embodiments, the wearable security system operates a self-defensive system. In some embodiments, the wearable security system communicates with an external sensor network.

Another aspect is a method of providing security to a wearer of a portable device. The portable device is controlled to collect data about the wearer and/or an environment of the wearer. The portable device is controlled to assess the data for a potential threat to the wearer. The portable device is controlled to notify the wearer of the potential threat.

### BRIEF DESCRIPTION OF THE DRAWINGS

These and other features, aspects, and advantages of the present disclosure will become better understood with reference to the following description, appended claims, and drawings where:

FIG. 1 is an example wearable security system.

FIG. 2 is an example method for wearable security.

### DETAILED DESCRIPTION

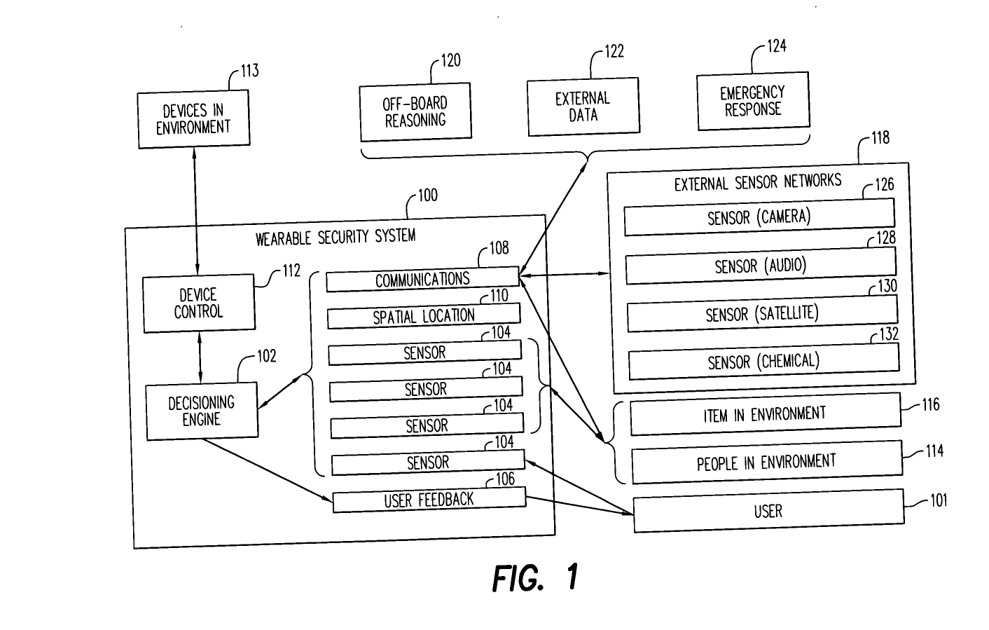

FIG. 1 shows an example wearable security system 100. Wearable security system 100 either resides in an item of clothing worn by a user or is portable, i.e. capable of being carried by the user, such as in a bag. Generally, wearable security system 100 monitors an environment 116, assesses possible threats, and provides other functions for the user 101. In this example, wearable security system 100 has a decisioning engine 102, a plurality of sensors 104, a user feedback component 106, a communications component 108, a spatial location component 110, and a device control component 112.

Decisioning engine 102 comprises a processor. Decisioning engine 102 monitors environment 116 and processes events to provide security and perform other functions of wearable security system 100. Decisioning engine 102 not only processes immediate events from environment 116 but also integrates this information over time and stores a personal history. Decisioning engine 102 develops a model of normal environmental conditions for user 101 in a profile. Decisioning engine 102 monitors current input and personal history, recognizes trends and events, determines if events fall within established limits, communicates with and controls items in environment 116, and provides feedback to user 101.

Decisioning engine 102 provides security and performs other functions of wearable security system 100 by interfacing with sensors 104, user feedback 106, communications component 108, spatial location component 110, and device control component 112. Decisioning engine 102 monitors environment 116 by receiving input from sensors 104, communications component 108, spatial location component 110, and device control component 112. Decisioning engine 102 processes events by processing input, learning and reasoning. Decisioning engine 102 communicates with environment 116 by sending and receiving messages through communications component 108, device control component 112, and user feedback component 106. Decisioning engine 102 controls environment 116 by sending and receiving information over device control component 112, communications component 108, and user feedback component 106. Decisioning engine 102 provides user feedback by sending information to user feedback component 106. Thus, decisioning engine 102 integrates other components of wearable security system 100 to provide security and other functions for user 101.

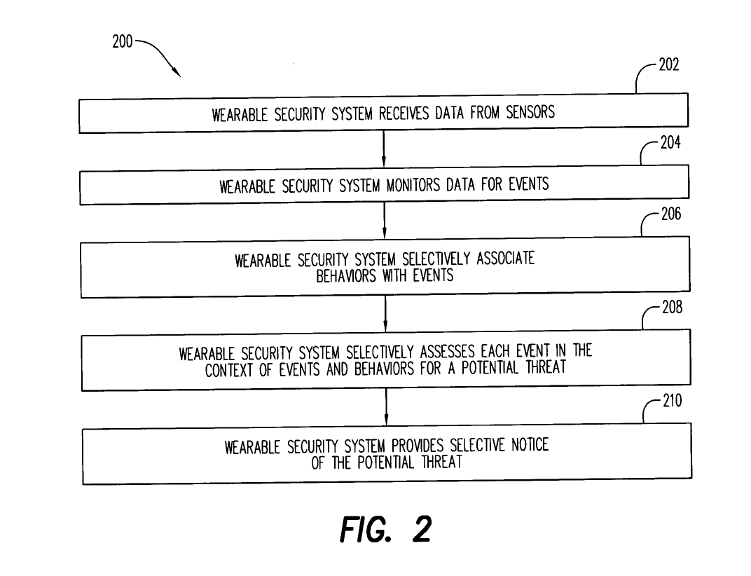

In some embodiments, decisioning engine 102 comprises a processor, and various software components, segmentation routines, such as state transition models, learning components, semantic and statistical models, and an inference engine. Segmentation routines segment data gathered from sensors into objects. A state transition model has states of objects and transitions between them. At any particular time, an object is in a particular state. The object stays in that state until something happens that causes the state to change, i.e. transition to another state. A change of state is an event. Learning components are various artificial intelligence programs for learning based on sensor input and previous reasoning. Semantic and statistical models are used to model data, objects, events, and behaviors. Decisioning engine associates behaviors with objects. An inference engine is part of an expert system used to reason over knowledge bases. An example of an inference engine is a Bayesian inference engine. In some embodiments, decisioning engine 102 assesses potential threats by reasoning over data, objects, events, and behaviors using models and learning. See FIG. 2 for an example method capable of being performed by decisioning engine 102.

Sensors 104 comprise any kind of sensor that can gather information to help wearable security system 100 become aware of environment 116. Examples of sensors 104 include optical sensors, such as cameras, inertial sensors, acceleration sensors, heading sensors, range finding devices, force/torque detectors, accelerometers, tactile sensors, sonar sensors, acoustic sensors, position measuring sensors, linear motion sensors, microphones, satellite sensors, chemical sensors, and the like. Sensor data is communicable to others via communications component 108. In some embodiments, sharing sensor data is conditioned on permission of user 101 or other established controls set by user 101.

User feedback component 106 is any kind of device or combination of devices capable of providing information to user 101. Examples are various audio devices, such as interactive voice response (IVR), visual devices, such as heads-up displays on glasses, kinesthetic devices, such as Braille systems, and other output perceivable by the senses of user 101. Because wearable security system 100 is aware of unfolding events that may not yet be perceivable by user 101, user 101 has more time to react to the event once notice is provided by user feedback component 106. User feedback component 106 is capable of providing time-to-impact of hazards, vocalizing that a threat has been reported, and providing log information and incident summaries. For example, user feedback component 106 informs user 101 that user 101 is in the wrong line and which line to move to. For example, user feedback component 106 receives input from a camera in external sensor networks 118 around the next corner from user 101 and provides a look-ahead view or a rearview to user 101.

Communications component 108 is any kind of communication device or combination of communication devices capable of communicating with people in the environment 114, items in the environment 116, and the like. Examples include a cellphone, a pager, a modem, a speaker, a visual device, an audio device, a kinesthetic device, and the like. In various embodiments, communications component 108 communicates with one or more of the following: external sensor networks 118, off-board reasoning 120, external data 122, and emergency response 124.

External sensor networks 118 is one or more networks of sensors external to wearable security system 100. In the example shown in FIG. 1, external sensor networks 118 comprises a camera 126, an audio sensor 128, a satellite sensor 130, and a chemical sensor 132. Other examples of external sensor networks 118 that are capable of providing input include local surveillance systems, satellite weather systems, time providing systems, libraries, the Internet, and the like. External sensor networks 118 provide a link to a larger sensor environment for wearable security system 100.

Off-board reasoning 120 comprises a processor. Off-board reasoning 120 is capable of processing information for and providing results to decisioning engine 102 via communications component 108. Off-board reasoning 120 is also capable of storing the personal history of user 101 and other information.

External data 122 is data or databases accessible to decisioning engine 102 via communications component 108. For example, to aid decisioning engine 102 in recognizing people in the environment 114, external data 122 comprises known offenders or people that user 101 has met or knows.

Emergency response 124 is people or entities to contact in case of an emergency. Examples of emergency response 124 include friends, relatives, police, or a guard force.

Spatial location component 110 is a device that provides a current location of user 101. An example of spatial location component 110 is a global positioning system (GPS). In an emergency, decisioning engine 102 receives a location from spatial location component 110 and sends the location via communications component 108 to emergency response 124. The current location of user 101 is capable of being provided to others upon request via communications component 108. In some embodiments, providing the current location of user 101 is conditioned on the permission of user 101.

Device control component 112 is one or more devices or systems for controlling devices in the environment 113. Devices in the environment 113 are a type of item in environment 116 and, thus, are capable of being sensed by sensors 104. Device control component 112 is capable of automatically controlling devices in the environment 113 via commands from decisioning engine 102 to increase the security and comfort of user 101. In a threatening situation, decisioning engine 102 sends commands to device control component 112 to initiate defensive systems, such as lasers and anti-germ devices. If decisioning engine 102 processes events indicating user 101 is interested in particular devices in environment 113, decisioning engine 102 sends commands to device control component 112 to manipulate devices in environment 113, such as turning down a radio. If decisioning engine 102 processes events indicating user 101 is about to run a red light, decisioning engine 102 is capable of sending commands to device control component 112 to signal the car to break. Generally, device control component 112 modifies environment 116 of user 101 depending on the situational events and the preferences of user 101.

FIG. 2 shows an example method 200 for wearable security, which is capable of operating wearable security system 100 and other example embodiments. Wearable security system 100 receives data from sensors 202. Wearable security system 100 monitors data for events 204. Wearable security system 100 selectively associates behaviors with events 206. Wearable security system 100 selectively assesses each event in the context of events and behaviors for a potential threat 208. Wearable security system 100 provides selective notice of the potential threat 210.

Wearable security system 100 monitors data for events 204. For example, wearable security system 100 executes computer vision algorithms to identify and interpret data gathered by cameras from the environment around user 101. Segmentation routines pick out objects from the scenes. Models are used to determine states, e.g. user 101 is walking in a building. A state transition is an event, e.g. user 101 walks from the building into a parking garage. Wearable security system 100 recognizes the event.

Wearable security system 100 selectively associates behaviors with events 206. Wearable security system 100 models the environment, e.g. by creating a graphical representation where each object is a node on a graph representing a network of inter-related agents. Wearable security system 100 reasons based on models, objects, events, and history to recognize behaviors associated with objects. For example, a graph is created representing various cars and people in the parking garage in relation to one another and to user 101. Wearable security system 100 recognizes behaviors, such as a person approaching user 101 from behind with a weapon. Once, a behavior is recognized, an assessment of threats is made.

Wearable security system 100 selectively assesses each event in the context of events and behaviors for a potential threat 208. For example, wearable security system 100 attempts to identify the person with the weapon and reasons that the behavior of approaching with a weapon is a threat to the safety of user 101.

Wearable security system 100 provides selective notice of the potential threat 210. For example, As a result of recognizing the threatening person with the weapon, wearable security system 100 produces a particular tone warning user 101 and takes appropriate action, such as calling 911 and attempting to identify the person.

Various example embodiments of wearable security system 100 have many applications and variations on method 200.

In one embodiment, wearable security system 100 detects threats and hazards to user 101 as user 101 is crossing a street. For example, wearable security system 100 receives images from cameras featuring a truck 202. Wearable security system 100 determines the event of the truck's position coming closer to the position of user 101 204. Wearable security system 100 associates the behaviors of approaching user 101 with a certain velocity and acceleration with this event 206. Wearable security system 100 assesses this event in the context of the position, velocity, and acceleration of user 101 as user 101 is standing in the street and determines it is a potential threat 208. Wearable security system 100 provides selective notice of the potential threat by alerting the police and warning user 101 with speech indicating user 101 should move out of the way quickly 210.

In another embodiment, wearable security system 100 avoids potential threats and hazards to user 101 as user 101 is driving a car. For example, wearable security system 100 receives information from the car user 101 is driving and additional information from external transportation systems 202. Wearable security system 100 determines the events of an upcoming traffic light changing to red and the car approaching the light at a high speed 204. Wearable security system 100 predicts future behavior and associates the behavior of running a red light with these events 206. Wearable security system 100 assesses these events under the circumstances, including the distance to the light and the car's present speed and the distance needed to break in time and determines it is a potential threat to the safety of user 101 208. Wearable security system 100 provides selective notice to user 101 and the car and causes the car to break and come to a stop in front of the light 210.

In another embodiment, wearable security system 100 maintains a log of sensor data and reasoning activity for use in further analysis or evidence in legal proceedings. For example, wearable security system 100 receives data from various cameras 202 as user 101 is going about her day. Wearable security system 100 monitors data for events indicating a known stalker is violating a particular restraining order 204 and determines the stalker has appeared numerous times during the day in various scenes captured by cameras. Wearable security system 100 selectively associates the behavior of following user 101 with these events. Wearable security system 100 selectively assesses these events as a violation of the restraining order 208. Wearable security system 100 records a record of these events and analyses, stores them in a log, and forwards the log to the appropriate predetermined people 210.

In another embodiment, wearable security system 100 provides a heads-up display indicating safe-passage through trouble spots and alerting user 101 of nearby hazards. Wearable security system 100 receives data from sensors 202 as user 101, a soldier, is in battle. Wearable security system 100 monitors data for events 204 of biohazards and determines a dangerous chemical in the environment is at a high level. Wearable security system 100 associates a behavior of releasing a chemical weapon with this event 206. Wearable security system 100 assesses this event in the context of the health risk to user 101 for a potential threat 208 and determines it is a potential threat. Wearable security system 100 releases specialized safety equipment, communicates the situation and the location of user 101 with others, and then provides a received voice stream to user 101 of instructions indicating a safe-passage 210.

In another embodiment, wearable security system 100 detects the environment of user 101 and detects potential control devices in the environment to adapt the environment according to the preferences of user 101. For example, wearable security system 100 receives data from microphones as user 101 is driving a car on a highway 202. Wearable security system 100 monitors this data for changes in background noise and determines that the background noise decreased as user 101 enters an off-ramp 204. Wearable security system 100 associates the behavior of a radio being too loud with these events 206. Wearable security system 100 assesses these events as a threat to the comfort of user 101 according to predefined preferences 208. Wearable security system 100 operates device control component 112 to lower the volume of the radio, allowing user 101 to continue to operate the car safely without distraction 210.

In some embodiments, wearable security system 100 detects and catalogs the impact of user 101 on the environment, such as noticing when people in the environment 114 are observing user 101. Wearable security system 100 receives data from sensors 202 including several images of known spies. Wearable security system 100 monitors data for the event 204 of known spies in the environment around user 101 looking in the direction of user 101. Wearable security system 100 associates the behavior of observing user 101 with these events 206. Wearable security system 100 assesses these events in the context of past events and behaviors and determines there is a potential threat 208. Wearable security system 100 communicates with off-board reasoning 120 and, then, provides information received from external data 122 about the identity of the known spies and when and where they have been or are observing user 101 to user 101 on a heads up display on glasses that user 101 is wearing 210.

In some embodiments, wearable security system 100 uses outside help to identify individuals in the environment around user 101, a security guard. Wearable security system 100 receives data from sensors 202, including several individuals in the environment around user 101 as user 101 is looking each of them. Wearable security system 100 monitors this data for events of individuals that user 101 does not know 204. Wearable security system 100 associates the behavior of being unknown to user 101 with these events 206 based on stored history at external data 122. Wearable security system 100 assesses these events in the context of persons known to user 101 by communicating with biometric systems in external sensor networks 118 to gather identity information about these individuals and reasons to determine their identities 208. Wearable security system 100 provides audible voice via a earplug to user 101 of the names and other identifying information about these individuals 210.

In some embodiments, wearable security system 100 helps user 101 to recall where personal effects were left. Wearable security system 100 receives data from cameras and motion detectors 202. Wearable security system 100 monitors data for the events of an image of car keys on a counter and user 101 moving his hand to put the car keys on the counter and then away 204. Wearable security system 100 associates the behavior of leaving car keys on the counter with these events 206. Wearable security system 100 stores the data, events, and behavior in a log. Wearable security system receives data from a microphone 202. Wearable security system 100 determines the data is speech from user 101 wondering where user 101 left the car keys. Wearable security system 100 assesses the behavior of wondering where the car keys are with finding the car keys 208 by reasoning and consulting the log in external data 122. Wearable security system 100 provides an image of the car keys on the counter with a time stamp on a display in user feedback 106 to help user 101 find the car keys 210.

In some embodiments, wearable security system 100 acts as a personal assistant offering services, such as identifying people within the range of sensors 104. Wearable security system 100 receives data from microphones, cameras, and motion detectors 202. Wearable security system 100 monitors data for events of people within the range of sensors and confusion on the face of user 101 who has Alzheimer's 204. Wearable security system 100 associates the behavior of confusion on the face of user 101 and a person in the line of sight of user 101 with user 101 not recognizing the person 206. Wearable security system 100 searches for images matching the person in the log at external data 122 and determines the identity of the person, acting as a personal assistant 208. Wearable security system 100 provides a name and image of the person to user 101 via an earphone 210 and a display 210.

In some embodiments, wearable security system 100 focuses on those events of most interest to user 101 and attempts to determine the intent not only of people and things in the environment, but also of user 101. Wearable security system 100 receives data from motion detectors, cameras, microphones and the phone system 202. Wearable security system 100 monitors data for the events of user 101 falling on the floor, user 101 reaching for the phone, knocking the receiver off the base, and tones coming from the receiver 204. Wearable security system 100 selectively associates the behaviors of user 101 having fallen and trying to get emergency help with these events 206. Wearable security system 100 assesses these events in this context and determines the intent of user 101 208. Wearable security system 100 contacts emergency response 124 and forwards data, events, and analysis information to emergency response 124, operates device control 112 to hang up the phone, and informs user 101, including giving any needed medical advice from off-board reasoning 120 and external data 122 to help 210.

In some embodiments, wearable security system 100 predicts approaching weather, such as tornadoes. Wearable security system 100 receives data from external sensor networks 118, emergency response 124, GPS, and other sensors 202. Wearable security system 100 monitors data for weather events 204. Wearable security system 100 associates the behavior of warning user 101 with the event of receiving a tornado warning for the area 206. Wearable security system 100 assesses these events in the context of events and behaviors and determines there is a potential threat 208. Wearable security system 100 provides selective notice of the potential threat 210.

In some embodiments, wearable security system 100 interacts with other wearable security systems 100 to share information. Multiple wearable security systems 100 in a neighborhood or community receive data from cameras and other sensors 202. This data is shared among multiple users 101. Wearable security systems 100 monitor data for events 204. Events are shared with multiple users 101. Wearable security systems 100 selectively associate behaviors with events 206. Behaviors are shared with multiple users 101. Wearable security systems 100 selectively assess each event in the context of events and behaviors for a potential threat 208. Potential threats are shared with multiple users 101. Wearable security systems 100 provide selective notice of the potential threat 210. Notice is shared with multiple users 101. Also, in large crowds of multiple users, tasks are partitioned and distributed among multiple users 101 for more effective load balancing and for providing graceful degradation if components of wearable security system 100 fail. For example, as users at the periphery of the crowd leverage processing power to outward looking cameras from users in the middle of the crowd. A handshaking protocol is used for secure communications within a group of users 101 as well as a protocol to drop members leaving the group of users 101. In this way, neighborhoods, communities, and the like may interact and communicate via multiple wearable security systems 100.

In some embodiments, wearable security system 100 provides a soundtrack to the life of user 101, providing different tempos and themes depending on the situation. Wearable security system 100 receives data from sensors 202. Wearable security system 100 monitors data for events 204. Wearable security system 100 selectively associates behaviors with events 206, such as walking alone in a parking lot at night. Wearable security system 100 selectively assesses each event in the context of events and behaviors for suitable music to increase of the comfort of user 101 208. Wearable security system 100 provides selective music 210.

In some embodiments, wearable security system 100 has an always-alert 24/7 mode so that user 101 is protected even during sleep. Wearable security system 100 receives data from sensors 202 while user 101 is sleeping. Wearable security system 100 monitors data for events 204. Wearable security system 100 selectively associates behaviors with events 206, such as a burglar breaking and entering the home of user 101. Wearable security system 100 selectively assesses each event in the context of events and behaviors for a potential threat 208. Wearable security system 100 wakes up user 101 to alert user 101 to the potential threat or takes evasive action on behalf of user 101 210.

Various embodiments of wearable security system 100 provide many advantages. Wearable security system 100 provides increased personal security not currently available to the average consumer. In many ways, wearable security system 100 provides an extended level of control by user 101 over the environment.

It is to be understood that the above description is intended to be illustrative and not restrictive. Many other embodiments will be apparent to those of skill in the art upon reviewing the above description, such as adaptations of the present disclosure to equipment or groups of people, such as police, neighborhood watch groups, search parties, and any other people or equipment that need security. Various designs using hardware, software, and firmware are contemplated by the present disclosure, even though some minor elements would need to change to better support the environments common to such systems and methods. The present disclosure has applicability to fields outside personal security, such as creating legal evidentiary records, inter-school or interoffice communication, tourist information, and other kinds of applications where users need to be aware of and control their environment. Therefore, the scope of the present disclosure should be determined with reference to the appended claims, along with the full scope of equivalents to which such claims are entitled.

1. A method for wearable security, comprising:
receiving data from at least one sensor of a wearable security system;
monitoring said data for events;
selectively associating behaviors with said events;
selectively assessing each event in the context of said events and said behaviors for a potential threat; and
providing selective notice of said potential threat.

2. The method according to claim 1, wherein monitoring said data for events comprises:
segmenting said data into objects; and
monitoring said objects for events.

3. The method according to claim 1, further comprising:
providing selective notice of said events.

4. The method according to claim 1, wherein a person is one of said objects.

5. The method according to claim 4, further comprising:
identifying said person.

6. The method according to claim 5, further comprising:
providing selective notice of said person.

7. The method according to claim 2, further comprising:
controlling said object.

8. The method according to claim 1, further comprising:
maintaining a selective history.

9. The method according to claim 1, further comprising:
operating a self-defensive system.

10. The method according to claim 1, further comprising:
communicating with an external sensor network.

11. A system for wearable security, comprising:
a decisioning engine for selectively assessing events for potential threats to a user, said decisioning engine having at least one state transition model for determining said events, at least one segmentation routine for determining objects, and an inference engine for associating events with behaviors;
a plurality of sensors for gathering data about said objects, said objects being the result of segmenting said data by said at least one segmentation routine, said plurality of sensors being in communication with said decisioning engine; and
a user feedback component for interacting with said user, said user feedback component being in communication with said decisioning engine;
wherein said decisioning engine, said plurality of sensors and said user feedback component reside in an article capable of being worn or carried by said user.

12. The system according to claim 11, further comprising:
a communications component for communicating with an external resource, said communications component being in communication with said decisioning engine;
wherein said communications component resides in said article.

13. The system according to claim 12, wherein said external resource comprises at least one resource selected from the group consisting of: an off-board reasoning component, an external data component, an emergency response component, an external sensor network, and any combinations thereof.

14. The system according to claim 13, wherein said external sensor network comprises at least one sensor selected from the group consisting of: a camera, an audio component, a satellite component, a chemical component, and any combinations thereof.

15. The system according to claim 11, further comprising:
a spatial location component in communication with said decisioning engine;
wherein said spatial location component resides in said article.

16. The system according to claim 11, further comprising:
a device control component for controlling at least some of said objects, said device control component being in communication with said decisioning engine;
wherein said device control component resides in said article.

17. A system for portable security, comprising:
a plurality of sensors for gathering data;
a user feedback component;
a device controller; and
a decisioning engine to monitor an environment with said plurality of sensors, recognize events, provide selective warnings with said user feedback component, and take actions with said device controller, said decisioning engine having at least one state transition model for determining said events, at least one segmentation routine for determining objects from said data, and an inference engine for associating events with behaviors;
wherein said device controller, said user feedback component, said communications component, said plurality of sensors, and said decisioning engine are capable of being worn or carried by a user.

18. The system according to claim 17, further comprising:
a communications component capable of being carried by said user.

19. The system according to claim 18, wherein said communications component communicates with an external sensor network.

20. The system according to claim 18, wherein said external sensor network comprises a plurality of sensors.

21. The system according to claim 20, wherein said plurality of sensors comprises at least one sensor selected from the group consisting of: a camera, a microphone, a satellite sensor, a chemical sensor, and any combination thereof.

22. The system according to claim 17, wherein said communications component communicates with at least one of the following: a reasoning engine, external data, and an emergency response system.

23. A method of providing security to a wearer of a portable device, comprising:
controlling the portable device to collect data about the wearer and/or an environment of the wearer;
controlling the portable device to assess said data for a potential threat to the wearer; and
controlling the portable device to notify the wearer of said potential threat.
